(19) United States
(12) Patent Application Publication
(10) Pub. No.: US 2003/0102261 A1
(43) Pub. Date: Jun. 5, 2003

(54) Uses and methods with condensates

(76) Inventors: Anthony Spencer Ford, Oxford (GB); James Alexander Mitchell, Ashford (GB); Spencer Edwin Taylor, Camberley (GB)

Correspondence Address: Nixon & Vanderhye, 8th Floor, 1100 North Glebe Road, Arlington, VA, 22201-4714, US

(21) Appl. No.: 10/182,578

(22) PCT Filed: Dec. 11, 2000
(86) PCT No.: PCT/GB00/04735

(30) Foreign Application Priority Data
Feb. 7, 2000 (GB) 0002778.9

(51) Int. Cl. B01D 11/00

(52) U.S. Cl. 210/639; 210/644; 210/708

(57) ABSTRACT

A method of purifying a mixture, said mixture comprising an oil Product, at least one additive and water, wherein: said oil Product is a liquid fuel oil composition or lubricating oil composition, at least part of the water is in the form of a dispersion of water in said Product, and said additive is a cyclic compound comprising m units of the formula (Ia) and n units of the formula (Ib) joined together to form a ring, wherein each y and Y² is a divalent bridging group which may be the same or different in each unit; R⁰ is H or (C₁-C₆) alkyl or is a metal cation, R⁵ is H or (C₁-C₆₀) alkyl; J is 1 or 2; R³ is hydrogen, a hydrocarbyl or a hetero-substituted hydrocarbyl group; either R¹ is hydroxyl and R² and R⁴ are independently either hydrogen, hydrocarbyl or heterosubstituted hydrocarbyl, or R² or R⁴ are hydroxyl and R¹ is either hydrogen, hydrocarbyl or hetero-substituted hydrocarbyl; and m+n is from 4 to 20, m is from 1 to 8 and n is at least 3; said method comprising: providing said mixture, coalescing at least part of said water in said dispersion into separable droplets of water, and separating said droplet water from an oil phase comprising the oil Product and Additive of reduced non-dissolved water content.

The present invention relates to uses of condensates and methods involving their use, the condensates being in particular cyclic calixarene compounds containing within the calixarene ring at least one unit of salicylic acid or salt thereof These compounds are particularly suitable as thermal stabilising additives in fuel and for use in lubricating oil compositions for medium or low speed diesel engines, especially four stroke engines. They are particularly useful in fuel compositions comprising said compounds, e.g. aviation fuel compositions.

In high speed aircraft, both civilian and military, the liquid fuel is combusted to produce power, but also is circulated in the aircraft as a heat exchange fluid to remove the excess heat generated at such speeds e.g. in lubricating oils. The fuel is thus maintained for long periods at high temperatures, which results in discoloration and decomposition to produce soluble coloured products and insoluble products such as gums, sediments and granular material; insoluble products can form deposits that reduce the heat exchange capacity and can block filters potentially causing loss of power. Soluble coloured by-products are unsightly and an indication of some decomposition. The cause of discoloration etc. may be from phenols, naphthenates and sulphur compounds and/or metals which are often present in the fuels.

In some oil fired devices, such as boilers and slow heating cookers, e.g. of the Aga type, kerosine oil fuel is passed down a narrow metal feed pipe to the combustion chamber where it is burnt. Parts of the pipe are sufficiently near the hot chamber for them to be heated to significant temperatures, resulting in the risk of thermal degradation of the fuel in the pipe, especially with slow feed rates and high residence times in the pipe. This degradation can form solid deposits which reduce the flow and ultimately stop it, causing the combustion to stop. To overcome this manufacturers of such devices have for many years recommended to their users that at least once each 6 months such pipe parts are cleaned of solid deposits of coke or other materials.

U.S. Pat. No. 5,478,367 describes the addition to diesel or jet fuel of a substituted unsaturated polyamine derivative dispersant to reduce particulate emissions on combustion and to reduce fouling i.e. deposition of insoluble deposits. The macrocyclic compounds preferably contain an N═C—N—C═O group and especially have fused rings, such as are made by reaction of a hydrocarbyl (e.g. fatty alkyl) succinic anhydride and a polyalkylene amine.

Canadian Patent Publ. 2067907 describes the addition to distillate jet fuels of hydroxylamines to stabilise them against degradation at elevated temperatures.

U.S. Pat. No. 5,468,262 describes addition to jet fuels of thermal stability additives which are prepared by reacting a polyamine, aldehyde and phenol to form a condensate which is then reacted with a succinic anhydride containing a polyolefin derived unsaturated group.

The additives are effective at 0.2% by weight.

EP-A-678568 describes addition to jet engine fuels of anti deposition agents which are derivatives of (thio)phosphonic acids.

In WO 99/25677 are described cyclic calixarenes which are cyclic phenolic aldehyde compounds having at least one structural unit in the cyclic ring derived from salicyclic acid or salts thereof These compounds, hereinafter called salixarenes, are described in WO 99/25677 for use in lubricating oil and gasoline and diesel in which they are stated to have detergent and thermal stabilising effects, while in WO 99 25793 we describe aviation fuels and/or kerosene compositions containing them also having a thermal stabilising effect.

The salixarene compounds are described in WO 99/25677 as cyclic compounds comprising m units of the formula Ia

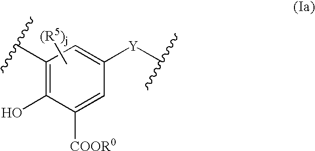

and n units of the formula (Ib)

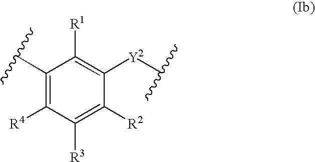

joined together to form a ring,

wherein each of Y and Y² is a divalent bridging group which may be the same or different in each unit; R⁰ is H or (C₁-C₆) alkyl or is a metal cation, R⁵ is H or (C₁-C₆₀) alkyl; and j is 1 or 2;

R³ is hydrogen, a hydrocarbyl or a hetero-substituted hydrocarbyl group; either R¹ is hydroxyl and R² and R⁴ are independently either hydrogen, hydrocarbyl or hetero-substituted hydrocarbyl, or R² and R⁴ are hydroxyl and R¹ is either hydrogen, hydrocarbyl or hetero-substituted hydrocarbyl; and m+n is from 4 to 20, m is from 1 to 8 and n is at least 3.

In addition in the definitions for Formula Ia and Ib in WO 99/25793 each of R¹, R2 and R⁴, which may be the same or different, is hydroxyl, hydrogen, hydrocarbyl or hetero-substituted hydrocarbyl, with the proviso that at least one of R¹, R², R⁴is hydroxyl.

In addition to the improved thermal stabilising effect imparted by the compounds of formula Ia/Ib to the fuels, the compounds have now been shown to have improved water tolerance properties. Fuels often pick up water during transport or as a contaminant, in particular in storage or processing. The presence of the water in the fuel is a problem if the fuel contains additives having surface active properties, because the latter stabilise emulsions of water and fuel, especially those made in high speed pumps e.g. in fuel transport lines. The stabilised emulsions increase the viscosity of the fuel. In addition when the fuel is gasoline, e.g. especially aviation fuel, such as jet fuel or aviation gasoline, the presence of water in the fuel is very disadvantageous, because in bulk form, the power developed on combustion is uneven and in bulk and droplet form it contributes to icing of the fuel on cooling, resulting in blocking of fuel jets causing loss of power, either temporarily or permanently. Thus many fuels especially aviation fuels are passed through coalescers en route from refinery to user to convert dispersed droplets of water to separable size droplets, which are then removed. The presence of any additives in the fuel with surface active properties causes the coalescers to fail and therefore the water not to be removed.

The compounds of formula Ia/Ib or Product A have a reduced tendency to stabilise emulsions of water, fuels and compound, compared to some known thermal stabilisers for aviation fuel, or detergents for formulated diesel or formulated gas oil (or for diesel base or gas base fuel (i.e. the hydrocarbon oil in the middle distillate boiling range)). By use of the compounds of formula Ib/Ib, the separation of water from the fuel is rendered more easy than with the other additives with less production of emulsions and intermediate phases between oil and water (according to the Institute of Petroleum IP 279/97 test), or faster breakage of dispersions (e.g. according to the ASTM D-1094 test). Thus the compounds are phase distinguishers helping to maintain a clear distinction between the water and oil phases, in contrast to the other additives which tend to reduce the distinction between or clarity of or sharpness of the interface between the oil and water.

The present invention provides a method of purifying a mixture of an oil Product which is a liquid fuel or lubricating oil composition, with at least one additive and water, at least part of the water being in the form of a dispersion of water in said Product, which method comprises providing said mixture in which said additive is an Additive (which herein means a compound of formula Ia/Ib or product A hereinafter), coalescing at least part of said water in said dispersion into separable droplets of water and separating said droplet water from an oil phase comprising the oil Product and Additive of reduced non-dissolved water content, especially one substantially free of non-dissolved water, e.g. water droplets or dispersed droplets. In the separation there are preferably produced water droplets and an oil phase, and no significant amount of interface material of oil and water. The method is preferably applicable when the oil Product is a hydrocarbon fuel, especially aviation fuel which may contain or may be substantially free of non-hydrocarbon performance additives (apart from the Additive) especially additives officially approved for aviation use.

The separation of water from fuels is performed at least once during the transport of the fuel from where it is made, in one part of a refinery, to the energy user, e.g. an engine of a means of transport on land, on or under sea, or in air, or an engine of a power or heat generator e.g. an electricity generator or heating boiler. For diesel and gasoline, water may be separated once during the transport of fuel, e.g. in a refinery or blend terminal after it leaves storage, but because of the greater importance of use of substantially water free aviation fuels, water may be separated from aviation fuels more than once during the fuel transport e.g. 2-6 times, such as after any storage e.g. in a refinery, blend terminal or airport storage tank, especially just before the fuel is passed at the airport to refuel an aeroplane or helicopter or hovercraft.

The mixtures of water, fuel and Additive especially compound of formula Ia/Ib, e.g. dispersions, are usually substantially free of anti-icing additives, especially for aviation fuel e.g. jet fuel, as are the fuels ready for combustion (i.e. as passed to the energy user) which comprises the purified fuel composition comprising fuel and said compound.

The presence of water is also .a problem in lubricants, both for land based vehicles, such as cars, trucks, buses and trains, and sea based transport e.g. ships, where marine lubricants need to function in the presence of sea water. The invention also provides the use of the Additive especially compound of formula Ia/Ib to restrict the formation of emulsions of water in a lubricant oil.

The oil Product to be purified in the method of the invention may be a blend of a first oil Product, especially a hydrocarbon fuel comprising said Additive, and a second oil Product, especially a hydrocarbon Fuel, which may be the same or different from the first oil Product and may contain, but preferably does not contain said Additive, each of the first and second oil Products being contaminated with water or susceptible of contamination with water.

Thus the present invention also provides a method of purifying an oil Product in which a first liquid oil Product comprising an additive is blended with a second liquid oil Product, at least one of said oil Products, and especially both, being contaminated with water or susceptible to subsequent contamination with water, water is mixed with one or both said oil Products if not already present therein, to produce a 2 phase mixture of said first and second oil Products, additive and water, at least some of the water being in a water in oil dispersion form, wherein said 2 phase mixture in which said additive is an Additive as herein before defined, is coalesced to produce water droplets, and the water is separated from an oil Product comprising said Additive of reduced water content. Preferably said oil Product is substantially free of undissolved water. Preferably the first oil Product is substantially free of non-dissolved water when it is blended with the second oil Product, which may or may not at that time contain undissolved water.

Thus the present invention also provides a blend of at least 2 liquid oil Products e.g. fuels, a first liquid oil Product comprising a first fuel or lubricant base, said Additive and dissolved water, and optionally undissolved water, and a second oil Product, e.g. fuel comprising a second fuel or lubricant base, which may be the same or different from the first base, and undissolved water. The fuel or lubricant bases may contain or may be substantially free of performance additives.

Instead of or as well as the first oil Product, e.g. fuel, comprising Additive being blended with said second oil Product, e.g. fuel, the invention is also beneficial when the second oil Product is passed separately through a line down which the first oil Product has passed, because in many cases the first passage of first oil Product leaves trace of said oil Product and Additive in this line, and/or the walls of the line have adherent or adsorbed Additive, removed from said first oil Product. By this means the second oil Product becomes contaminated with said Additive which in the case of other additives have adversely affected its water tolerance properties; this effect is greatly reduced with the Additives compared to the known thermal stabilisers.

Thus the present invention also provides a method of transporting at least 2 oil Products, e.g. fuels, separately along the same line, each oil Product e.g. fuel being contaminated with water or susceptible to contamination with water, wherein the earlier oil Product passing along the line comprises said Additive, and after passage down said line each oil Product containing water at least partly in dispersal form, is coalesced to produce droplets of water which are separated to leave an oil Product of reduced water content, especially substantially free of non-dissolved water, and preferably with substantially no interface e.g. less than 10% (based on the total value of separated water and interface).

In all the above methods of the invention, a benefit of the invention is that with some other thermally stabilising additives there are substantial interface problems of the stage of separation of the drops e.g. with an amount of interface of at least 20% (of the value of separated water and interface).

The Additives have the effect of thermally stabilising the oil Products e.g. lubricant such as automative or marine lubricant and fuels e.g. aviation fuel, diesel, gas oil or gasoline, and also of not causing significant interfacial problems when water is separated from mixtures of the oil Product. This latter property is very important commercially for reasons as explained above.

Thus the present invention also provides the use (a) of the Additive to stabilise thermally a liquid oil Product e.g. fuel, especially a jet fuel, while at the same time rendering the stabilised oil Product substantially water immiscible or rendering it substantially non-emulsifiable to water. The use is thus of a combined heat stabiliser and phase separator.

The invention also provides the use (b) of the Additive to stabilise thermally a liquid oil Product, e.g. fuel, especially a jet fuel, without substantially affecting its interfacial tension (e.g. by less than 20% of the value of the oil Product e.g. fuel without the Additive). This use is thus of a combined heat stabiliser and interfacial tension maintainer. This technical effect is in contrast to some other known thermal stabilisers, e.g. for jet fuel that have a significant surface active effect and severely reduce the interfacial tension of the fuel (e.g. by more than 30% of the value of fuel without the stabiliser).

The invention also provides the use (c) of the Additive to stabilise thermally a liquid oil Product e.g. fuel, while enabling it also to pass the single element test as defined as in the current edition of API 1581 (Specification and Clarification procedures for Aviation Jet Fuel Filter/Separators).

The Additive also can have a dispersant effect in diesel and/or gasoline, instead of or as well as a thermal stabiliser effect, so the above uses a-c can also be expressed in a similar manner with the two technical effects being the dispersant effect (rather than the thermal stabilising effect) and the non-emulsion stabilising effect e.g. phase separator or interfacial tension maintainer effect.

In addition known thermal stabilisers, e.g. for jet fuel, also adversely affect the active surfaces of coalescers, in which the fuel with dispersed water contacts the active surface effecting coalescing of the dispersed water droplets causing then to grow from a size of less than 1 micron to produce droplets of size at least 1 mm. The active surface of a successful coalescer is sufficiently hydrophilic to have the above effect, but in the presence of the known stabiliser the surface becomes more hydrophobic and tends to lose its coalescence power. Eventually the coalescer cannot fullful its function of coalescing water in the fuel and has to be replaced. The Additives have a much reduced effect on the active surface of the coalescer compared to the known stabiliser, thereby increasing the lifetime of the coalescer.

The present invention therefore also provides a method of increasing the lifetime of a coalescer, which is used to coalesce water present in a water dispersion in an oil Product, which comprises having in the oil Product an Additive. The dispersion of water oil Product and Additive is converted into droplets of water or a separate water phase, and an oil Product phase containing the Additive of reduced non-dissolved water content, and preferably substantially no interface of water and oil Product.

The coalescer usually comprises a fibre bed, often of different fibre diameters, pore size or density. The overall bed may be a random mixture of the above fibres, but preferably is in graded layers, to coalesce dispersions of wide range of water droplet sizes. The fibres usually have an affinity for water but are not completely hydrophilic; they may be polymeric with polar groups e.g. CONH, —COO—, but not alcoholic OH, as in cellulose, or cellulose ethers or esters; these fibres are of non-cellulosic polar polymers. Alternatively the fibres can be inorganic e.g. glass fibre especially glass treated with polar molecules such as glass treated with an organoxy-aminoalkyl silane or glass fibres bonded with phenolic resins e.g. phenol formaldehyde resins; these are hydrophobised inorganic fibres.

Coalescers and their structure and apparatus describing them are described in R. L. Brown and T. H. Wines, Hydrocarbon Processing December 1993 pp95-100 the disclosure of which is herein incorporated by reference.

In this specification the term “Additive” means a cyclic compound with structural units of formula Ia/Ib as described and defined above with respect to WO 99/25793 and also with the option of R⁰ being an ammonium cation (including quaternary ammonium cation), and also the reaction Product A hereinafter defined or a product separated from said reaction product.

Thus the cyclic compound Additive comprises m units of formula Ia and n units of formula Ib, wherein Y and Y² are divalent bridging groups, which may be the same or different; R³ is hydrogen, a hydrocarbyl or a hetero-substituted hydrocarbyl group; each of R¹, R² and R⁴, which may be the same or different, is hydroxyl, hydrogen, hydrocarbyl or hetero-substituted hydrocarbyl, with the proviso that at least one of R¹, R², R⁴ is hydroxyl, and m+n is 4 to 20, m is 1-8 and n is at least 3. In formula Ia the OH group is in the ortho position to the COOR⁰ group. Preferably at least one of the following features (a) to (e) is met, namely the cyclic compound comprises at least one of (a) at least one formula (Ia) unit in the form of a carboxylate anion especially at least 2 carboxylate anions (b) at least one formula (Ia) unit in the form of an alkaline earth metal or alkali metal carboxylate salt, preferably a potassium or sodium salt, especially a potassium salt (c) at least 2 e.g. 3 or 4 units of formula (Ia) (d) an m+n value of 5-11, preferably 7-9 and especially 8 and (e) the cyclic compound is in the substantial absence of linear species comprising formula (Ia) and (Ib) units and/or or the substantial absence of unreacted formula (Ia) and (Ib) units, (e.g. of formula Ia and Ib hereafter).

Preferably the cyclic compound has at least 2 of (a) (b) (c) (d) and (e) preferably 3, most preferably 4 and especially all 5 in particular (a) and (c), or (b) and (c), and especially (d). In a preferred embodiment the cyclic compound is on wherein m is 2, n is 6, and both the units of formula (Ia) are in the form of a potassium carboxylate salt, and the cyclic compound comprises the substantial absence of linear species comprising formula (Ia) and (Ib) units and the substantial absence of unreacted formula (Ia) and (Ib) units.

When more than one salicylic acid unit is present in the ring (i.e. m>1), the salicylic acid and phenol units may be distributed randomly, although this does not exclude the possibility that in some rings there may be several salicylic acid units joined together in a row. Thus the m and n units may be joined in block and/or randomly. Preferably the cyclic compound consists essentially of units of formula Ia and Ib.

In the formulae Ia/Ib Y and Y² may each independently be a hydrocarbyl bridging group or be a hetero-substituted hydrocarbyl group or up to 50% mole of the totality of Y and Y² group may be a hetero atom. The hydrocarbyl bridging group is preferably aliphatic and has a chain of 1-4 carbon atoms; preferably the group is of formula (CR⁷R⁸)_{d}, e.g. (CHR⁸)_{d} where each of R⁷ and R⁸, which may be the same or different, represents hydrogen or hydrocarbyl e.g. of 1-6 carbons, such as methyl or ethyl and d is an integer of 1-4 preferably 2 or especially 1; advantageously the group is of formula (CHR⁶) or (CHR⁸)_{d} where R⁸ is as defined above preferably methyl or especially hydrogen. Y and/or Y² may also represent a hetero-substituted hydrocarbyl group with a hetero atom, e.g. O, S or NH interrupting a chain of carbon atoms e.g. 2-4 carbon atoms, such as in CH₂OCH₂, CH₂SCH₂ or CH₂NHCH₂. Up to 50 mole % of the totality of Y¹ and Y² groups may be a hetero atom e.g. O or NH or especially 5, e.g. 1-50 mole % especially 8-20 mole % of said groups. Preferably Y and Y² are hydrocarbyl groups, and the compound of formula Ia/Ib is sulphur free.

Each of R¹, R² and R⁴ represents hydroxyl, hydrogen, hydrocarbyl or hetero-substituted hydrocarbyl with the proviso that at least one of R¹, R² and R⁴ represents hydroxyl. Thus all three may represent hydroxyl as in a phloroglucinol derivative, or two as in a resorcinol derivative (i.e. the compound of formula I contains a resorcinarene group), or one as in a phenol derivative. Preferably either R¹ is hydroxyl and R² and R⁴ are independently either hydrogen (which is preferred), hydrocarbyl or hetero-substituted hydrocarbyl, or R² and R⁴ are hydroxyl and R¹ is either hydrogen, hydrocarbyl or hetero-substituted hydrocarbyl.

Regarding R¹ to R⁵ and R⁸, the term “hydrocarbyl” includes (C₁-C₆₀) alkyl such as t-butyl, t-amyl, s-butyl, isopropyl, octyl, nonyl, dodecyl and octadecyl. Alternatively the hydrocarbyl group may be derived from a polyolefin, for example polyethylene, polypropylene, polybutylene or a polyolefin copolymer, for example an ethylene/propylene copolymer, preferably derived from a polyisobutene. Alternatives include isoprene-butadiene, styrene-isoprene or styrene-butadiene block copolymers such as those disclosed in WO 96/40846, or ethylene-propylene and ethylene-butene-1 copolymers having molecular weights from 1500 to 2500 or 7500, as disclosed in U.S. Pat. No. 5,567,344 and U.S. Pat. No. 5,578,237. Mixtures of all the above may also be employed. Any hetero-substituted hydrocarbyl group has the heteroatom, preferably —O— or ═NH, interrupting a chain of carbon atoms, such as an alkoxy-alkyl group of 2-20 carbons. Each of R¹-R⁵ may otherwise be as described for R³ below.

The hydrocarbyl group for R¹, R²or R⁴usually has 1-14, e.g. 1-6 carbons and is preferably saturated, especially an alkyl group, e.g. methyl, ethyl, propyl, butyl or hexyl group. The hetero-substituted hydrocarbyl group has at least one, e.g. 1-3, especially 1 hetero atom e.g. O, S or NH interrupting a chain of carbon atoms, e.g. 2-20. or 2-6 carbons as in an alkoxy alkylene group such as ethoxy ethyl.

R³ is hydrogen, hydrocarbyl or a hetero-substituted hydrocarbyl group. Preferably R³ is hydrocarbyl or a hetero-substituted hydrocarbyl in at least R³ group in the compound of formula I, especially with n such groups in the molecule. The hydrocarbyl group may be alkyl, alkenyl, cycloalkyl, aryl, aralkyl and contains at least 1 especially at least 4 or at least 8 carbon atoms, e.g. 4-40 carbons, in particular with 8-20 carbons, in a chain. Preferred are linear or branched alkyl, e.g. of 8-24 or 8-20 carbons, such as decyl, dodecyl, tetradecyl, hexadecyl, octadecyl, lauryl, myristyl, stearyl, palmityl, propylene trimer or tetramer, or alkenyl e.g. of 6-24 carbons such as oleyl, or cycloalkyl e.g. of 5-8 carbons such as cyclohexyl, aryl, e.g. of 6-24 carbons, such as phenyl, tolyl and alkylphenyl with 6-16 carbons in the alkyl, e.g. dodecylphenyl, and aralkyl e.g. of 7-26 carbons such as benzyl and alkyl substituted benzyl with 6-16 carbons in the alkyl, e.g. dodecyl benzyl. R³ may also represent a polymeric hydrocarbyl group e.g. from a polyolefin group, especially from one or more olefins of 2-6 carbons such as ethylene, propylene, butene, isobutene; the polymeric groups may be from polyethylene, polypropylene, polybutene, an ethylene propylene copolymer or polyisobutene (which is preferred). Molecular weights of polymeric R³ groups may be 300-6000, e.g. 500-2000. In the compound of formula I, there may be different R³groups in the same molecule.

In the compound of formula I, m is from 1 to 8, e.g. 1-4, especially 2, or in particular 1, while n is at least 3 e.g. 3-10, in particular 5-9 especially 6-8. The sum of m+n is 4-20, preferably 5-10 in particular 7-9, e.g. 6 or 8, or a mixture of compounds with m+n having the value of 6 and 8. Preferably m is 1 or 2 and m+n is 5-10 e.g. 8.

In preferred salixarenes Y, Y¹ or Y² is CH₂; R¹ is hydroxyl; R² and R⁴ are independently either hydrogen, hydrocarbyl or hetero-substituted hydrocarbyl; R³ is either hydrocarbyl or hetero-substituted hydrocarbyl; R⁰ is H or is substituted by an alkali metal ion, in particular a potassium ion; R⁵ is hydrogen or an alkyl group of 6 to 50 carbon atoms, preferably 4 to 40 carbon atoms, more preferably of 6 to 25 carbon atoms; j is 2 or preferably 1; and m+n has a value of at least 5, preferably at least 6, typically at least 8, where m is 1 or 2, preferably 1.

More preferably R² and R⁴ are hydrogen; R³ is hydrocarbyl, preferably alkyl of 10 greater than 4, preferably greater than 9 carbon atoms; R⁵ is hydrogen; and m+n is from 6to 12 e.g. 8;m is 1 or 2.

In preferred compounds, R² and R⁴ are hydrogen, m is 1 or 2, n is 5, 6 or 7, m+n is 6 and/or 8, R¹ is hydroxyl, R³ is alkyl of 8-20 carbons e.g. dodecyl or octadecyl, or polyisobutenyl.

The metal in the salt form may be an alkali metal e.g. Li, Na, K, Rb or Cs, or an alkaline earth metal e.g. Mg or Ca, or the salt may be an ammonium or a quaternary ammonium salt, e.g. of formula NR¹R²R³R⁴ wherein R¹-R⁴ are as defined above, especially with at least 3 and in particular 4 of them of less than 10 carbons.

For convenience the cyclic compounds are herein referred to as “salixarenes”.

For a review of calixarenes the reader is referred to ‘Monographs in Supramolecular Chemistry’ by C David Gutsche, Series Editor—J Fraser Stoddart, published by the Royal Society of Chemistry, 1989. Calixarenes having a substituent hydroxyl group or groups include homocalixarenes, oxacalixarenes, homooxacalixarenes and heterocalixarenes.

Salixarenes for use in the present invention may be made by reacting together appropriate amounts of the optionally substituted salicylic acid (or carboxylic ester), an optionally substituted phenol, and a carbonyl compound which is preferably an aldehyde e.g. formaldehyde, or acetaldehyde, especially in the presence of a base and optionally a catalyst. The reaction may be performed in the presence of sulphur if the compound of formulae Ia/Ib is to contain combined sulphur.

The salixarenes may be made by a process comprising reacting together, usually in the presence of a basic catalyst, compounds of the formulas (IIa) and (IIb)

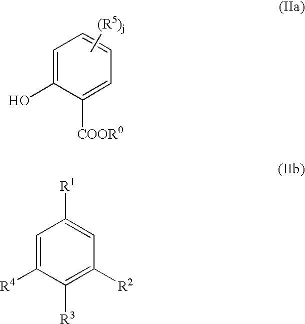

with an aldehyde or ketone of the formula O═CR⁷R⁸ e.g. O═CHR⁸, and optionally sulphur or with a dihalide YX₂, or Y²X₂; where R⁰ to R⁵, R⁷, R⁸ and j, Y, and Y² are as defined previously and X is chlorine, bromine or iodine.

Preferred basic catalysts are alkali metal hydroxides such as sodium hydroxide, potassium hydroxide and lithium hydroxide.

A proportion of the product may comprise linear molecules. Linear molecules are also composed of units having formulas (Ia) and (Ib) except that instead of the ends of the molecule being joined to form a ring, each end has a terminal group which is independently one of the following:

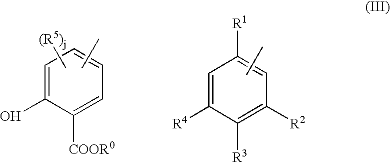

In the linear molecule the total number of units m+n is from 2 to 20, m is from 1 to 8 and n is at least 1. A product for use in the invention may be the product (herein also called Product A) of reacting compounds of the formulas (IIa) and (IIb) above with an aldehyde or ketone of the formula O═CR⁷R⁸ e.g. O═CHR⁸, and optionally sulphur; where R⁰ to R⁸ are as defined previously, which reaction product preferably comprises at least 20% by weight of a cyclic compound comprising units of formulas (Ia) and (Ib) and no more than 80% of the linear version of said compound. Preferably the cyclic form comprises at least 40%, more preferably at least 60% and most preferably at least 80% by weight of the reaction product. Product A also can include but may exclude products isolated from said reaction product, but preferably includes said isolated cyclic products, containing the COOR⁰ group(s).

The process may be performed with an amount of base which is 0.01-0.2 equivalents per mole of the salicylic acid, with the base being effectively in catalytic amount.

The process may be performed in a melt or in the presence of water or a solution or suspension. The water may be added with the base, e.g. aqueous sodium or potassium hydroxide solution, and/or a possible solvent for the formaldehyde (e.g. 10-30% formaldehyde solution), the amount of added water being usually 1-20% of the total S weight of the reactant e.g. 5-15%. Advantageously the process is performed with the water present initially, and then once reaction has started, then any water present as well as water produced as by product is removed, e.g. by evaporation or distillation, whether under reduced pressure, and/or heating at above 110° C.

The process may also be performed in the presence of an inert organic liquid which may be a solvent for at least one of the reactants, e.g. the phenol and/or salicylic acid and/or a solvent or non solvent for at least one of the phenolic products, especially a salixarene e.g. of formula Ia/Ib and/or a linear phenolic species. The liquid is usually a hydrocarbon of atmospheric boiling point 100-160° C., such as toluene or a xylene or methylbenzene. The amount of liquid may be 10-90% of the total weight of solvent and reactants, especially 50-90%. Preferably the liquid is immiscible with water and can entrain water in its distillation and/or reflux, e.g. a Dean and Stark apparatus.

At the end of the reaction, the solvent if any may be evaporated to leave a crude product, or the reaction product (optionally with solvent) treated or used as such.

The direct product of the process to make the salixarenes may be used as such (i.e. without purification from other phenolic compounds) or may be converted from one salt form to another, e.g. via ion exchange, or by way of acidification to form the free acids, and then if desired formation of a salt by neutralisation. Preferably the direct product is purified to increase its content of cyclic and/or carboxylic species. The direct product may be distributed between a substantially water immiscible organic solvent, e.g. an aliphatic liquid hydrocarbon, such as kerosene or hexane or an aromatic hydrocarbon such as toluene or xylene, and an aqueous medium. The medium may be basic, e.g. with an alkali metal hydroxide or especially carbonate or bicarbonate, in which case the aqueous medium can extract the carboxylic species, while the non carboxylic species remains in the organic phase, the phases are then separated and then carboxylic salt recovered from the aqueous phase, or acidified to free carboxylic acid and recovered from an organic phase. The direct product may also be purified, when dissolved in organic solvent, by addition of a compound capable of producing a salt insoluble in the solvent, e.g. addition of a barium salt (as such or in organic or aqueous solution) can cause precipitation of an insoluble barium carboxylate salt, which may be separated from the non carboxylic compounds. Acidification of the barium salt enables the free carboxylic acid to be recovered.

The direct product in organic solution is e.g. an aliphatic or aromatic hydrocarbon such as one described above, may be contacted with an anion exchange resin, so that the carboxylic compound(s) are bound to the resin, while the non carboxylic compounds are not. The treated resin may then be separated and treated with alkali metal hydroxide or alkoxide solution to regenerate the resin for reuse and to liberate the alkali metal salt of the carboxylic acid. The process may be batch wise or continuous (with a pair of resins in parallel, one for separation while the other is being regenerated). The resin is preferably a macroreticular one, and usually has quaternary ammonium cationic substituents; an example of such a resin is that sold under the Trade Mark Amberlyst 15.

The direct product may also be purified by shape selective separation by contact of the direct product (in acid or salt form) in organic solution with an inorganic porous solid, whose pores are insufficiently large to allow the salixarene to enter, but allow the linear products to enter. Preferred maximum diameter for pores are 100A, especially <70 or <50 A and especially above 20A. Examples of such porous solids are silica, alumina and silica/alumina as well as ceramic membranes, e.g. made of alumina or zirconia. The contact may be batch wise, e.g. passage of the direct product onto a bed of the solid and then elution of the cyclic compounds therefrom as the first eluted fraction; such beds may be in columns in parallel, one for separation of the cyclics while the other is being eluted of the other non cyclic materials. Preferably the separation is continuous e.g. in a cross flow made and/or with a tube of ceramic membrane, through the walls of which the non cyclics pass while the cyclics pass down the tube and are concentrated.

Preferably to make the compounds of formula Ia/Ib in which at least some, and preferably substantially all, the carboxylic groups are in salt form, the amount of base is at least 0.2 equivalents per mole of the salicylic acid, in particular 0.2-10, such as 0.9-5 especially 2-5 or about 1. The base chosen is usually the one which provides the cations required in the product, e.g. sodium or potassium hydroxide or carbonate to provide sodium or potassium salixarene salt. If desired the base for the reaction may be different, and then the reaction product salt may be converted into the desired salt e.g. via ion exchange. Thus an alkali metal base can be used in the reaction and the salt converted to for example quaternary ammonium or calcium, salt form. In addition instead of adding the salicylic acid as free acid into the reaction process a preformed salt thereof may be used, e.g. sodium or potassium salicylate, in the form for example of a solid or in aqueous solution.

Preferably to make the compounds with at least 2 carboxylic acid groups per ring, whether those groups are in acid or salt form or both, the process preferably involves reaction of the salicylic acid and the phenol in a molar percentage of at least 20% salicylic acid units based on the total of salicylic and phenol e.g. 20-90%, such as 20-40%. Advantageously the amount of base present is 0.2-8 equivalents, based on the equivalents of carboxyl groups in the salicylic acid e.g. 2-5 equivalents.

Preferably to make the salixarenes with a ring containing 5-11 aromatic rings (derived from the phenol and salicylic acid), especially with 7-9 such aromatic rings, and 1-3, in particular 2 or 3 salicylic rings, the process usually involves the presence of a base with a cation of appropriate size, the larger the cation the larger the ring. Thus while a spread of salixarene ring sizes is obtained, the average is lower for Li e.g. 5-7, than Na e.g. 6-8, than K 7-9 and Cs 9-11.

The fuel or lubricating composition e.g. jet fuel composition may also contain a non ring i.e. linear form of the compound of formula Ia/Ib, i.e. with structural units as shown in the Formulae Ia/Ib but terminated usually by the phenol and/or salicylic acid units.

The present invention also provides the use of at least one of these “salixarenes” for the water tolerance effect as well as to reduce the discoloration on heating of fuel compositions e.g. jet fuel and fuel compositions comprising kerosine.

The preferred Additive is dodecyl-salicylic calix[8]arene, which is a Salix[8]arene comprising 7 dodecyl substituted phenolic units and one salicylic acid unit joined by methylene bridges. Another preferred Additive compound is the corresponding salixarene with 2 salicylic groups and 6 dodecylphenol units preferably at least partially as an alkali metal salt e.g. potassium salt and especially in the form of the dipotassium salt.

The Additive may be present in the composition in amount of at least 1, at least 5 ppm, such as 1-1000, 5-1000 e.g. 5-500 especially 5-200 or 10-100 ppm based on the weight of the composition e.g. the jet fuel composition. The Additive may be mixed with the jet or other fuel composition in the form of a concentrate in solution, e.g. in an aliphatic aromatic hydrocarbon in 20-80% w/w solution, or it may be added as such to give a solution in the fuel. More than one of the salixarenes may be present e.g. 2-4, especially differing only in the values of at least one of m and n, especially n.

The composition can comprise jet fuel. The composition can comprise kerosine, in particular in jet fuel. The main component of the jet fuel itself is usually a middle boiling distillate boiling point in the range 150-250° C. at atmospheric pressure and the fuel is usually kerosine which may be mixed with gasoline and optionally light petroleum distillate as in mixtures of gasoline and kerosene. The jet fuel may comprise mixtures of gasoline and light petroleum distillate, e.g. in weight amounts of 20-80:80-20 such as 50-75:50-25 which weight amounts may also be used for mixtures of gasoline and kerosene. The jet fuels for military use are designated JP4 to 8 e.g. JP4 as 65% gasoline/35% light petroleum distillate (according to US Mil. Spec. (MIL 5624G)), JP5, similar to JP4 but of higher flash point, JP7, a high flash point special kerosene for advanced supersonic aircraft and JP8, a kerosene similar to Jet A1 (according to MJL 83 133C). Jet fuel for civilian use is usually a kerosene type fuel and designated Jet A or Jet A1. The jet fuel may have a boiling point of 66-343° C. or 66-316° C. (150-650° F. e.g. 150-600° F.), initial boiling point of 149-221° C., e.g. 204° C. (300-430° F., e.g. 400° F.), a 50% boiling point of 221-316° C. (430-600° F.) and a 90% boiling point of 260-343° C. (500-650° F.) and API Gravity of 30-40. Jet fuel for turbojet use may boil at 93-260° C. (200-500° F.) (ASTM D1655-59T). Further details on aviation fuels may be obtained from “Handbook of Aviation Fuel Properties”. Coordinating Research Council Inc., CRC Report No. 530 (Society of Automotive Engineers Inc., Warrendale, Pa., USA, 1983) and on US military 25 fuels, from “Military Specification for Aviation Turbine Fuels”, MIL-T-5624P.

The jet fuel may be the straight run kerosene optionally with added gasoline, but preferably has been purified to reduce its content of components contributing to or encouraging formation of coloured products and/or precipitates. Among such components are aromatics and olefins and mercaptans. Thus the fuels may be purified to reduce their mercaptan content e.g. Merox fuels and copper sweetened fuels or to reduce their sulphur content e.g. hydrofined fuels or Merifined fuels. Merox fuels are made by oxidation of the mercaptans and have a low mercaptan S content (e.g. less than 0.005% wt S) such as 0.0001-0.005% but a higher disulphide S content (e.g. at most 0.4% or at most 0.3% wt S such as 0.05-0.25 e.g. 0.1-2%); their aromatic (e.g. phenolics) and olefins content are hardly changed. Hydrofined jet fuels are ones in which the original fuel has been hydrogenated to remove at least some of sulphur compounds e.g. thiols and under severe conditions to saturate the aromatics and olefins; hydrofined jet fuels have very low sulphur contents (e.g. less than 0.01% S by weight). Merifined fuels are fuels that have been extracted with an organic extractant to reduce or remove their contents of sulphur compounds and/or phenols. The jet fuel may also contain metals, either following contact with metal pipes or carried over from the crude oil; examples of such metals are copper, nickel, iron and chromium usually in amounts of less than 1 ppm e.g. each in 10- 150 ppb amounts. Merox and hydrofined fuels are preferred and may be used in JP 4-8 jet fuels.

The fuel comprising kerosine may also be a fuel for combustion especially for non motive purposes, e.g. power generation, steam generation, and heating, especially for use 15 in buildings and for cooking, e.g. as described above. The fuel is particularly suitable for the devices e.g. boilers and slow cookers as described above in which there is localised preheating of the fuel before it is combusted. Such fuels are known as burning kerosine and may have the same physical properties as the kerosine based jet fuels described above, e.g. straight run kerosine, or kerosine modified to reduce its content of at least one of aromatics, olefins and sulphur compounds, as described above. The fuel may also contain metals as described above.

The fuel compositions contains the cyclic compound of formula Ia/Ib or I and may also contain at least one conventional additive e.g. for jet fuels or burning fuels such as an antioxidant, corrosion inhibitor, dispersant/detergent, (in particular in the case of hydroxy carboxylic acids (see below)), especially in amounts each of 1-1000 ppm, e.g. 20-200 ppm. The “salixarene” additives of formula I or Ia/Ib may be present in the composition especially with a dispersant; the dispersant is in particular one for solids known for use in fuels e.g. automotive burning or aviation fuels. Such dispersants usually have a polymeric carbon backbone with pendant groups containing nitrogen, which may be primary, secondary or tertiary, in cyclic or acyclic systems, and especially in amine, amide or imide groupings, in particular cyclic imide groups. The dispersants may also contain 1-5 polymer chains which are bridged by the nitrogen containing groups. Examples of such dispersants are the reaction products of polyisobutene succiic anhydride (PIBSA) and polyamines. Such dispersants are known compounds for dispersing particles of in non aqueous systems e.g. hydrocarbon systems. The weight ratio of “salixarene” to dispersant may be 99:1 to 10:90, especially 30:70 to 70:30. The additives and the fuel composition are preferably substantially ashless. Burning kerosine is usually substantially free of the above additives apart from that of formula Ia/Ib.

The fuel compositions containing the compounds of formula Ia/Ib or Product A, have an improved thermal stability as shown by a reduced tendency to discolour and/or produce solids on heating compared to the fuel alone (in the isothermal corrosion and oxidation test (ICOT based on ASTM D487 1)). In some cases the combination of the compounds of formula I and certain other hydroxy carboxylic acid derivatives imparts to some fuels further improved stability still, better than either additive alone. This synergistic behaviour is found with combinations of the compound of formula Ia/Ib and the hydroxycarboxylic acid in Merox fuels.

Thus in a preferred embodiment of the invention there is used a blend comprising at least one compound of formula Ia/Ib or Product A and at least one hydroxy carboxylic acid (different from said compound) with at least one chain of at least 8 carbon atoms. Thus the method of use of the invention can also involve a fuel composition comprising said blend and a fuel comprising kerosine and/or a jet fuel which is a Merox fuel, especially one which has a mean deposit forming tendency in the ICOT test according to ASTM D4871 of 80-120 mg deposit per litre of fuel, in particular 80-105 mg/l.

In this blend the weight ratio of the compound (c) of formula Ia/Ib to hydroxycarboxylic acid is usually 10-90:90-1, in particular 30-85:70-15 and especially 35-65:65-35. The amount of the blend in the fuel is usually 10-1000 ppm e.g. 30-200 ppm.

The hydroxycarboxylic acid contains in total at least 1 hydroxyl group e.g. 1-4 such as 2 or 3 but preferably 1 hydroxyl group. It usually contains a hydroxyl group on a carbon atom alpha, beta or gamma to the carbon atom to which the carboxylic acid group is bonded and may optionally have 1 or more hydroxyl groups elsewhere in the molecule: preferably the only hydroxyl group in the molecule is in the alpha, beta or gamma especially the beta position. The hydroxy acid may be of formula,

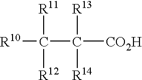

wherein one of R¹¹ and R¹³ represents hydrocarbyl and the other hydrogen or an organic group, each of R¹⁰, R¹² and R¹⁴, which may be the same or different, represents hydrogen or an organic group, bonded via carbon or a heteroatom, which is O, N or S, with the proviso that at least one, and preferably only one of R¹⁰-R¹⁴ represents an organic group containing a carbon chain of at least 8 carbon atoms. Examples of the organic groups, bonded via carbon are alkyl, cycloalkyl, alkenyl, aralkyl or aryl, e.g. as described for R³ above, especially an alkyl group of 8-3 000 carbons, in particular 8-24 carbons especially dodecyl, octadecyl, and 50-3000 carbons e.g. polyolefinyl such as from polyisobutene. Examples of the organic group bonded via nitrogen are amino groups with long chain hydrocarbyl group e.g. 8-24 carbons, or amido or imido groups from long chain carboxylic acids with 8-3000 carbons, e.g. 8-24 carbons such as fatty acids e.g. stearic and palmitic acids, or 50-3000 carbons e.g. polyolefinyl such as from a carboxylic derivative from polyisobutene such as PIBSA. In particular R¹¹ preferably represents hydroxyl/or hydrogen, R¹⁰ represents hydrogen or a long chain hydrocarbyl group of at least 8 carbons, especially 8-24 or 50-3000 carbons, R¹² represents hydrogen or alkyl of 1-6 carbons e.g. methyl or ethyl, R¹³ represents hydroxyl or hydrogen and R¹⁴ represents hydrogen or a amino, amido or imido group with a long chain aliphatic group or long chain mono or di acyl group, in particular a long chain succinic imide e.g. PIBSA. Especially R¹⁰ or R¹⁴ contains a long chain aliphatic group but not both. Preferred examples of the hydroxy carboxylic acid are N(long chain acyl) derivatives of beta hydroxy amino acids e.g. serine and threonine and long chain hydrocarbyl alpha hydroxy acids e.g. 1-hydroxy dodecanoic, 1-hydroxypalmitic and 1-hydroxystearic acids, 1-hydroxyl polyiso butenyl-1-carboxylic acid (from PIB aldehyde).

The use or method of the invention can also involve a fuel composition comprising liquid hydrocarbons, at least a majority of which boil at atmospheric pressure at 251-350° C. (according to ASTM D86). The hydrocarbon fuel may be diesel oil (e.g. as defined in European Standard EN590: 1993, the disclosure of which is herein incorporated by reference), but is preferably gas oil (e.g. as defined in its European Standard the dislcosure of which is herein incorporated by reference), especially with a boiling range of 251-410° C. The gas oil is a hydrocarbon fraction boiling between kerosine and light lubricating oil. The gas oil may be straight run gas oil, from direct distillation of crude oil under atmospheric pressure, cracked gas oil, which has the above boiling range and is made by distillation of the product of cracking high boiling or other oils either thermally or catalytically, or vacuum gas oil, with the above boiling range made by vacuum distillation of a residue, e.g. from a crude oil distillation or cracked oil distillation, or visbroken gas oil, made by treating one of the above gas oils to reduce its viscosity. The liquid hydrocarbon in the fuel composition may also be a product of hydrotreating or hydrofining a gas oil as described above; more information on these is provided below.

The fuel composition can thus contain at least a majority of a gas oil e.g. 5 1-100% (of the liquid hydrocarbons) e.g. at least 70% such as 70-90%, with usually up to 30% by weight (of total liquid hydrocarbons) of liquid hydrocarbons boiling above or below the gas oil, e.g. kerosine bp 150-250° C. and heavy gas oils of Final Boiling Point 350-410° C. Blends comprising a majority of gas oil with a minority of kerosene, or a majority of gas oil with a minority in total of kerosine and the heavy gas oil are preferred. The fuel composition may contain one or more of the types of gas oil discussed above, preferably with straight run gas oil and at least one other gas oil, especially with at least 50% or at least 70% of the straight run gas oil and up to 30% in total of one or more other gas oils e.g. cracked gas oil.

The fuel may comprise diesel fuel itself e.g. for use in diesel engines for motive use such as automobiles, trucks and buses, rather than the cruder gas oil, which contains diesel and a wide range of liquid hydrocarbons of boiling point above and below diesel. The gas oil is preferred for non motive uses. The fuel may also comprise biofuel from vegetable and/or animal sources, such as rapeseed oil esters e.g. the methyl ester, especially in weight ratios to liquid hydrocarbons of bp 251-350° C. of 5-30:95-70.

The liquid hydrocarbons in the fuel for use in the invention may have at least one of and preferably all of the following distillation properties 220-250° C. an initial bp (IBP) of 140-220° C., a 10% distillation point of 190-250° C., 50% distillation point of 220-250° C., 90% distillation point of 280-380° C. (e.g. 300-350° C.) 95% distillation point of 320-380° C (e.g.340-360° C.) and a Final Boiling Point of 290-385° C. (such as 330-360° C.).

The hydrocarbons may have Conradson Carbon contents (by weight) of 0.01-1 e.g. 0.01-0.1 or 0.1-1. They may have aniline points of 40-80° C. e.g. 60-75° C. (as in gas oils) or 10-40 e.g. 15-30 (as in diesel oil). They may have a Specific Gravity of 0.80-0.90, e.g. 0.82-0.88 or 0.82-0.86, and a minimum Flash Point of at least 38° C. (Closed, Abel.) or at least 55° C. such as 75-95° C. (Closed Pensky Martens). The cetane Number may be at least 40, 45, 49 or 51 such as 40-55, e.g. 45-48 or 49-54, but especially 40-49 or 45-49 as in gas oil. The sulphur chemical analysis may be less than 0.5% sulphur compounds (expressed as elemental S) such as 0.0001-0.5%, preferably less than 0.2% or 0.05% or 0.01% S, such as 0.05-0.2% S. The aromatic contents of the liquid hydrocarbons is usually less than 40% total aromatics e.g. 20-40% but especially less than 20% such as 5-15% total aromatics.

The liquid hydrocarbons e.g. gas oil or diesel preferably have been purified to reduce their content of components contributing to or encouraging formation of coloured products and/or precipitates or sulphur oxides on combustion. Among such components are aromatics and olefins and sulphur compounds. Thus the fuels may be purified to reduce their sulphur content e.g. hydrofined fuels or Merifined fuels. Hydrofined fuels are ones in which the original fuel has been hydrogenated to remove at least some of sulphur compounds e.g. thiols and under severe conditions to saturate the aromatics and olefins; hydrofined fuels have very low sulphur contents (e.g. less than 0.01% S by weight). Merifined fuels are fuels that have been extracted with an organic extractant to reduce or remove their contents of sulphur compounds and/or phenols. The fuel of the invention may also contain metals, either following contact with metal pipes or carried over from the crude oil; examples of such metals are copper, nickel, iron and chromium usually in amounts of less than 1 ppm e.g. each in 10-150 ppb amounts. Hydrofined fuels are preferred.

The fuel compositions for use in the invention include the cyclic compound of formula Ia/Ib and may also contain at least one conventional additive for automotive, heating or burner fuels e.g. an antioxidant, corrosion inhibitor, stabilisers, pour point depressant, demulsifiers, antifoams. cetane improvers, lubricity additives, anti-static additives, dehazers, lubricity additives package compatibilisers and dispersant/detergent, (in particular in the case of hydroxy carboxylic acids (see below)), especially in amounts each of 1-1000 ppm, e.g. 20-200 ppm. In particular the fuel compositions, in particular diesel or gasoline, and/or dehazer can comprise the Additive in the substantial absence of a demulsifier and yet able to meet a rating level less than 4 in test IP 289/97 parts (a), (b), and (c). The “salixarene” Additives may be present in the composition especially with a dispersant; the dispersant is in particular one for solids known for use in fuels e.g. heating or burner fuels. Such dispersants usually have a polymeric carbon backbone with pendant groups containing nitrogen, which may be primary, secondary or tertiary, in cyclic or acyclic systems, and especially in amine, amide or imide groupings, in particular cyclic imide groups. The dispersants may also contain 1-5 polymer chains which are bridged by the nitrogen containing groups. Examples of such dispersants are the reaction products of polyisobutene succinic anhydride (PIBSA) and polyamines. Such dispersants are known compounds for dispersing particles of in non aqueous systems e.g. hydrocarbon systems. The weight ratio of “salixarene” to dispersant may be 99:1 to 10:90, especially 30:70 to 70:30. The additives and the fuel composition are preferably substantially ashless.

The fuel compositions containing the compounds of formula Ia/Ib or Product A, have an improved thermal stability as shown by a reduced tendency to discolour and/or produce solids on heating compared to the fuel alone. In some cases the combination of the compounds of formula Ia/Ib and certain other hydroxy carboxylic acid derivatives imparts to some fuels further improved stability still, better than either additive alone in particular with Merox fuels.

Thus the fuel composition may also include at least one hydroxy carboxylic acid (different from said compound) with at least one chain of at least 8 carbon atoms, such as is described above.

The fuels may be used in combustion apparatus for motive use or in particular for non motive use in which the fuel is subjected to heating to a temperature e.g. of 100-400 ° C. such as 200-300° C. before combustion e.g. by proximity to the combustion chamber or otherwise (which may be at 500-700° C.). The feed pipes to the combustion chamber are usually made of metal e.g. copper or steel such as stainless steel, which may become corroded resulting in metal leaching into the oil encouraging degradation. The oil may be emitted into the chamber via a nozzle which becomes hot. The combustion may be in a vaporising burner in which metal in the burner chamber is heated by the flame and in turn vaporises the fuel; examples of such burners are vaporising and pot burners. The combustion is preferably in an atomising burner in which the fuel is atomised either directly, as in pressure jet burners (of low, medium or high pressure) (including simple and wide range burners) and blast burners, or indirectly as in rotary cup burners in which a sheet of fuel is made first and then atomised by contact with air. The atomising burners usually have a hot nozzle on and in which degradation deposits can form. The combustion apparatus may be used to produce heat directly as in industrial furnaces, e.g. for metals or ceramics, or industrial or domestic central heating or cooking as in slow cookers (e.g. of the Aga type) or for raising steam, e.g. process steam. Primarily the apparatus is used for raising power as in gas turbines for electrical power generation.

The invention also provides methods and use of lubricating oil compositions suitable for medium- or low-speed diesel engines, typically the four-stroke trunk-piston engine comprising said cyclic compound. Details of suitable lubricating oils and their other additives in addition to the cyclic compound are described in WO 9925677, the disclosure of which is hereby incorporated by reference, and the corresponding salts e.g. overbased calcium salts of the cyclic compound may be used in the methods/uses of the invention.

The invention is illustrated in the following Examples.

### EXAMPLE 1 AND 2

1. Preparation of crude 6 dodecyl 2 salicylic calix(8)arene di potassium salt.

A reaction was performed between 234.5 g dodecylphenol (0.87 moles, 1 equiv) 17.25 g salicylic acid (0.125 moles, 0.152 equivs) 60 g paraformaldehyde (2.00 moles, 2.3 equivs) and 73.5 g 10M potassium hydroxide (40% aqueous) (0.525 moles, 0.63 equiv)

A reaction apparatus was then set up incorporating the 5L flange flask, a flange lid and clip, overhead stirrer with paddle and PTFE stirrer gland, and double surface condenser and distillate collector. The reactor contents were heated by an electric mantle/thermocouple/Endotherm temperature controller system. The glassware from just above the mantle to just below the condenser was lagged with wool.

The reaction mixture was rapidly heated to 90° C., and the temperature then further increased very slowly at a rate of approximately 1° C. every 10 minutes. Water (77 ml) was collected over period of 7 hours, at the end of which the temperature had reached 140° C. The mixture was then allowed to cool overnight before being heated at about 140° C. for a further 2.5 hours. The product, a crude brown residue was the crude cyclic compound.

2. Preparation of purer 6 dodecyl 2 salicylic calix(8)arene di potassium salt.

The crude brown residue was dissolved in hexane and applied to an activated silica chromatography column (Kieselgel 60 Activated at 150° C. for 2 hr), from which it was separated by successive elution by hexane (35 ml), hexane/dichloromethane(DCM) (1:1 vv) (80 ml), dichloromethane (50 ml), dichloromethane/tetrahydrofuran (THF) (50 ml) and tetrahydrofuran (50 ml). Quantitative recovery of 5 fractions 1-5 was obtained in the approximate weight ratio of 33, 23, 7, 15 and 21%. The fractions were analysed by IR, NMR (H and C Scanning electron microscopy and also tested for their thermal stabilising effect on a B99/1 11 aviation base fuel, which was POSF 2827 (from USAF).

The stability tests were Jet Fuel Thermal Oxidation Tests (JFTOT) and were performed as described in EP-A-660077 the disclosure of which is herein incorporated by reference. In the test the fuel contacts a heated standard aluminium tube under limited oxygen to produce deposits on the tube surface, the thickness of the deposits being determined either by colour (according to ASTM 3241) or ellipsometry according to EP-A-660077. The tubes were heated at 335° C. for 5 hr, and the deposit volume found from the thickness profile by ellipsometry.

The results of the thermal stability tests were as follows.

| | | | Thermal deposition analysis | |
|---|---|---|---|---|
| | | | Concentration | |
| Fraction | Eluant | Mass % | (mgl⁻¹) | Deposition (ppb)* |
| 1 | Hexane | 33.4 | 8.3 | 21.5 |
| 2 | 1:1 | 22.5 | 5.9 | 148.5 |
| | Hexane/DCM | | 12.2 | 112.7 |
| 3 | DCM | 7.2 | 1.8 | 251.9 |
| 4 | 4:1 | 15.4 | 4.04 | 138.0 |
| | DCM/THF | | | |
| 5 | THF | 21.0 | 6.4 | 187.3 |

*The deposition results in the Table show the concentration of the various fractions in the fuel and the volume of deposit obtained expressed per volume of the fuel Fraction I eluted as a band with the solvent front suggesting low polarity material excluded from the silica pores.

The ¹Hnmr spectrum of fraction 1 showed the presence of kerosene and hexane so the weight of solid in it is probably about 10% of the total crude residue.

The ¹Hnmr and IR specta of Fraction 1 accorded with a cyclic salicylic acid/dodecyl phenol structure with rings bridged by methylene, while the SEM analysis and mass spectroscopy of the deposits on the JFTOT tubes shows the presence of K. Elemental analysis on Fraction 1 (after evaporation of kerosene and hexane accorded with 2CO⁻₂ anionic groups and 2K⁺ cations per mole. Fraction 1 is the product of Ex.2.

Fractions 2-5 are non carboxylic fractions of high or low molecular weight and of poor activity, compared to Fraction 1.

### EXAMPLES 3-5

Water Separation Tests

The tendency of any additive to cause emulsification of a mixture of an oil, specifically aviation fuel, and water can be tested according to the procedure given in Institute of Petroleum test IP289/97. In this test the components are mixed and allowed to separate and the volume change of the aqueous layer and the appearance of the interface between the aqueous layer and oil are noted.

Hazy blends were made of a diesel base fuel with 100 mg/l of the reaction product of Ex.1, (Ex.3) and also separately a known diesel detergent additive sold by Ethyl as Hitec 9654 (Comp. Ex.3). The diesel base fuel which was a commercial summer grade low S fuel meeting the standard EN 590 and with properties as follows, density 0.8342 hg/l, S 0.05% w/w KV at 40° C. 1.74 cSt. boiling properties ° C. IBP156°, T10 199°, T50 277°, T90 351° and FBP 388° C., CFPP −4° C., Cloud Pt 1° C. The blends were tested for demulsification according to IP289/97 and in the Texaco haze test in which a sample of the fuel to be tested is circulated through a glass reservoir via a pump in the presence of a fixed volume of water. The degree of haze is defined by transferring the fuel to a 500 ml wide neck Jar and comparing the haze with a set of standard photographs rated 1-6 in order of increasing haze content. In the present text the blend was tested to determine how many days it took for the blends to clear at room temperature.

The results were as follows.

| | Example 3 | Comparative Ex. 3 | Blank |
|---|---|---|---|
| Haze test | 0 | 2 | 1 |
| (days to clear) | | | |
| IP 289/97 | 3/2/1 | 4/3/20 | 3/2/0 |

In the IP289/97 test, the results e.g. 3/2/0 means the ratings allocated respectively to the (a) nature of the interface, the (b) degree of separation of the phases, and (c) the volume of interface. Thus in (a), 3 means loose lace or slight scum or both, while 4 means tight lace or heavy scum or both. In (b), 2 means complete absence of all emulsions or precipitates within the oil or water layer or upon the oil layer, apart from small air bubbles or small water droplets in the oil layer. In (b) 3 means emulsions or precipitates within either layer or upon the oil layer, or droplets in the water layer, or adhering to the cylinder wall (excluding the walls above the oil layer).

The product containing salixarene of Ex.1 thus gave better water separation results than a commercial detergent, and very nearly the same as the base fuel alone.

### EXAMPLES 4 AND 5

Water Separation Test

Another water separation test is that given in ASTM D-3948 and involves vigorously mixing fuel with water to 1000 ppm water content and various levels of additive. The emulsion produced is passed to a coalescer and the residual turbidity of the organic phase produced is measured and the organic and aqueous phases produced are separated. The turbidity of the organic phase is measured.

In the present case the test was done with the aviation fuel used in Ex. 2 as the fuel and as additives the crude product of Ex.1 and also separately the purified material (Fraction 1) of Ex.2.

The results were as follows, compared to a blank with the fuel but no additive, 100% corresponding to clear non turbid blank fuel.

| | Additive | Conc. Of Add. mg/l | Relative Unturbidity % |
|---|---|---|---|
| Ex. 4 | Ex. 2 | 1.6 | 99 |
| | | 4.3 | 75 |
| | | 11.1 | 67 |
| | | 41.9 | 61 |
| Ex. 5 | Ex. 1 | 5.1 | 99 |
| | | 24.9 | 95 |
| | | 52.0 | 90 |
| | | 104.7 | 75 |

### EXAMPLE 6

In addition the interfacial tension of the fuel composition comprising the aviation fuel of Ex.2 he cyclic compound of Ex.2 (Fraction 1) at varying concentrations was measured according to standard test base on the drop volume technique, the results being as follows.

| Conc. Of Additive mg/l | Interfacial tension mN/m by drop volume |
|---|---|
| 0 | 49.3 |
| 14 | 45.9 |
| 22 | 44.1 |
| 142 | 41.2 |

### EXAMPLE 7

The hazy fuel composition of Ex.4 with 1000 ppm water and 41.9 mg/l of the additive of Ex.2 is coalesced in a coalescer, which has a central longitudinally extending hollow core surrounded concentrically by layers of phenolic resin coated glass fibres of progressively outwardly decreasing fibre thickness and increasing packing density. The core is closed at one end distant from the other end to which the hazy fuel composition which is an emulsion of water in fuel, is passed. The emulsion moves into the fibres where the emulsified droplets causing the haziness are converted to droplets of larger diameter and leave a clear fuel. The mixture of fuel and droplets is passed to a separator and the water removal to give an aviation fuel for combustion substantially free of undissolved water.

### EXAMPLE 8

The diesel fuel used in Ex. 3 was mixed with the product of Ex. 1 at a treat rate of 100 ml/M³ of the fuel and tested for detergency and the inhibition of crude coking in the XUD-9 nozzle coking tests. The results were as follows. % coked at 0.1 mm left Blank (fuel) Average 90.0, Ex. 8 Average 78.1, 0.1-0.5 mm left Blank Average 57.1, Ex. 8 Average 53.4. Thus the product of Ex. 1 has both detergency effect and water tolerance (see Ex. 3).

1. A method of purifying a mixture, said mixture comprising an oil Product, at least one additive and water; wherein:
said oil Product is a liquid fuel oil composition or lubricating oil composition,
at least part of the water is in the form of a dispersion of water in said Product, and
said additive is a cyclic compound comprising m units of the formula Ia 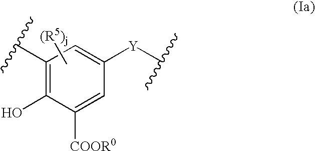
and n units of the formula (Ib) 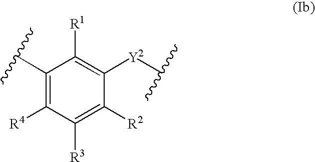
joined together to form a ring,
wherein each of Y and Y² is a divalent bridging group which may be the same or different in each unit;
R⁰ is H or (C₁-C₆) alkyl or is a metal cation,
R⁵ is H or (C₁-C₆₀) alkyl;
j is 1 or 2;
R³ is hydrogen, a hydrocarbyl or a hetero-substituted hydrocarbyl group;
either R¹ is hydroxyl and R² and R⁴ are independently either hydrogen, hydrocarbyl or heterosubstituted hydrocarbyl, or
R² and R⁴ are hydroxyl and R¹ is either hydrogen, hydrocarbyl or hetero-substituted hydrocarbyl; and
m+n is from 4 to 20, m is from 1 to 8 and n is at least 3;
said method comprising:
providing said mixture,
coalescing at least part of said water in said dispersion into separable droplets of water,
and separating said droplet water from an oil phase comprising the oil Product and Additive of reduced non-dissolved water content.

2. A method as claimed in claim 1, wherein said oil phase is substantially free of non-dissolved water.

3. A method as claimed in any preceding claim, wherein the oil Product is a hydrocarbon fuel, especially aviation fuel.

4. A method as claimed in any preceding claim, wherein the oil Product is a blend of a first oil product comprising a fuel oil composition or lubricating oil composition and said Additive, and a second oil product comprising a fuel oil composition or lubricating oil composition, which may be the same as or different from the hydrocarbon fuel of the first oil product,
each of the first and second oil products being contaminated with water or susceptible to contamination with water.

5. A method as claimed in claim 4, wherein said second oil product is substantially free of said Additive.

6. A method as claimed in claim 4 or 5, wherein the first oil product is substantially free of non-dissolved water when it is blended with the second oil Product.

7. A method of transporting a first oil Product and a second oil Product separately along the same line, each oil Product being contaminated with water or susceptible to contamination with water, said method comprising:
sequentially, in any order, passing along the line:
i) a first oil Product comprising an Additive as defined in claim 1 and
ii) a second oil Product; and thereafter,
coalescing any water present in said oil Products in dispersed form, to produce droplets of water;
separating said droplets of water from said oil Products to leave an oil Product(s) of reduced water content, especially substantially free of non-dissolved water, and preferably with substantially no interface.

8. A method of increasing the lifetime of a coalescer for coalescing water present in a water dispersion in an oil Product,
said method comprising introducing into the coalescer a mixture comprising said oil Product, at least one Additive and water;
wherein:
said at least one Additive is the Additive defined in claim 1.

9. Use (a) of an Additive as defined in claim 1,
for improving the thermal stability of a liquid oil Product, and rendering the stabilised oil Product substantially water immiscible or substantially non-emulsifiable with water.

10. Use of an Additive as defined in claim 1,
for improving the thermal stability of a liquid oil Product, without substantially affecting its interfacial tension (e g. by less than 20% of the value of the oil Product without the Additive).

11. Use of an Additive as defined in claim 1,
for improving the thermal stability of a liquid oil Product, while enabling it also to pass the single element test as defined as in the edition of API 1581, which was current at the earliest priority date of this application i.e. Feb. 7, 2000 (Specification and Clarification procedures for Aviation Jet Fuel Filter/Separators).

12. A method as claimed in any one of claims 1 to 8, or a use as claimed in any one of claims 9 to 11, wherein said Additive is characterized in that at least one of the conditions a) to e) below is satisfied:
(a) the cyclic compound comprises at least one formula (Ia) unit in the form of a carboxylate anion,
(b) the cyclic compound comprises at least one formula (Ia) unit in the form of an alkaline earth metal or alkali metal carboxylate salt,
(c) the cyclic compound comprises at least 2 units of formula (Ia)
(d) the cyclic compound comprises an m+n value of 5 to 11, and
(e) the cyclic compound is in the substantial absence of linear species comprising formula (Ia) and (Ib) units and/or or the substantial absence of compounds of the formula (IIa) and (IIb) below:

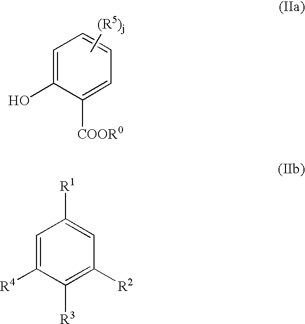

13. A method or use as claimed in claim 12, wherein
either R¹ is hydroxyl and R² and R⁴ are independently either hydrogen, hydrocarbyl or hetero-substituted hydrocarbyl, or
R² and R⁴ are hydroxyl and R¹ is either hydrogen, hydrocarbyl or hetero-substituted hydrocarbyl.

14. A method or use as claimed in claim 12 or 13, wherein Y is CH₂.

15. A method or use as claimed in any one of claims 12 to 14, wherein R¹ is hydroxyl, R² and R⁴ are hydrogen, and R³ is an alkyl of 8 to 20 carbon atoms.

16. A method or use as claimed in any one of claims 12 to 15, which comprises at least 2 of (a), (b), (c), (d) and (e).

17. A method or use as claimed in claim 16, which comprises (c) and at least one of (a), (b), (d) and (e).

18. A method or use as claimed in claim 16 or 17 which comprises at least three of (a), (b) (c), (d) and (e).

19. A method or use as claimed in claim 18, which comprises (c), (d) and at least one of (a), (b) and (e).

20. A method or use as claimed in claim 12, wherein
m is 2, and
n is 6.

21. A method or use as claimed in any one of claims 12 to 20, wherein at least one of COOR⁰ groups is in the form of an alkali metal salt, preferably, a lithium, sodium or potassium salt.

22. A method or use as claimed in claim 21, wherein at least one of the COOR⁰ groups is in the form of a potassium salt.

23. A method or use as claimed in claim 22, wherein said Additive is a 1-salix[8]arene comprising six dodecyl substituted phenolic units, and two salicylic acid unit joined by methylene bridges.

24. A method or use as claimed in claim 23, wherein said Additive is in the form of its dipotassium salt.
